(19) United States
(12) Patent Application Publication
(10) Pub. No.: US 2018/0184601 A1
(43) Pub. Date: Jul. 5, 2018

(54) Self-Watering Insert For A Plant Container

(71) Applicant: Earl Brian Graffius, Senoia, GA (US)

(72) Inventor: Earl Brian Graffius, Senoia, GA (US)

(21) Appl. No.: 15/861,614

(22) Filed: Jan. 3, 2018

Related U.S. Application Data
(60) Provisional application No. 62/441,562, filed on Jan. 3, 2017.

(51) Int. Cl. A01G 27/00

(52) U.S. Cl. CPC A01G 27/00; A01G 9/02

(57) ABSTRACT

Disclosed is a self-watering-insert for placement within growing containers, the insert comprising a one-piece self-supporting structure having an open bottom end, a closed top end, tapered sidewalls, an open or closed interfacing structure that facilitates a secure seal of the insert against an interior wall of the growing container, an open collar on the top to allow temporary insertion of a pipe or water-discharging mechanism into the watering insert, a plurality of holes and/or screen/fabric material permanently attached to the surface of the top end, allowing water and air to pass through the surface. A lower flange extends circumferentially around the bottom end of the water insert, thereby creating a shelf upon which growing medium rests; the flange further featuring downward protruding fins spaced so as to provide gateways through which water passes from underneath the interior of the watering insert to its exterior.

### CROSS-REFERENCES TO RELATED APPLICATIONS

This patent application claims the benefit of priority from previously-filed U.S. provisional patent application, Ser. No. 62/441,562, filed on Jan. 3, 2017, and further, claims the benefit of content of said provisional application as though fully appearing herein.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

### (1) Field of the Invention

Self-watering containers allow plants to go extended periods of time without having to be watered by means of providing a reservoir to hold water and deliver the water to the plants as needed. The problem with most of these systems is they require the buyer to purchase the container and self-watering device together. These systems are very bulky and expensive. Most retailers are not going to set aside valuable shelf space for such bulky items. The bulk of these items also make them more expensive to ship, transport, and warehouse.

The “prior art” systems are also bulky to store when the growing season is over. This results in a need to have a device that allows common containers such as standard 5-gallon buckets to be converted in to self-watering planters. One object of the present inventive concept is to render planters mote affordable and provided profiles and dimensions to make both the container and watering device stackable. This will result in the use of minimal storage space in the off-season. The disclosed inventive devices will also minimizing retail shelf space, storage space, warehousing space, and shipping costs associated with the commerce of the device.

There exist similar devices and methods to convert common containers into self-watering planters. Some of these devices and methods also fulfill the need to be compact and easy to store, ship, and warehouse. However, the problem with most of these devices and methods is that they are complex to use and/or require assembly and disassembly before and after use. Many of the current and prior art systems require that either the device be modified before use, assembled, or that other materials such as wicks be used to accomplish their intended function. The present inventive concept meets the need for a device that requires no modification, assembly, or the requirement of other materials to accomplish its intended function.

### (2) Description of the Related Art, Including Information Disclosed Under 37 CFR 1.97 and 1.98

There are a limited number of devices that show features similar to the inventive concept disclosed. Among them are the following:

U.S. Published Patent Application #2015/0164010; Jun. 18, 2015. This device is a disclosure of a one-piece drop-in device which converts buckets into self-watering container systems used for growing plants.

U.S. Pat. No. 9,161,500; Oct. 20, 2015, which discloses a self-watering system for a potted plant comprising a liquid container and an insert with an in-use position against the potted plant pointing upper part extending at least partially through an opening in the pot bottom.

U.S. Pat. No. 8,381,441; Feb. 26, 2013, which discloses an insertable watering device for a standard bucket, comprising a circular planar base member, central chamber, plurality of wicks, fill tube, and support legs.

U.S. Pat. No. 7,856,755; Dec. 28, 2010. The device disclosed is a planter system comprising of at least a water retaining vessel, bedding material layer, structure surrounding the retaining vessel and at least one fill tube, all components in a working combination.

### BRIEF SUMMARY OF THE INVENTION

The present invention discloses a stackable one-piece self-supporting watering insert 1 that displaces growing medium in a container-bound plant to create a water reservoir. More particularly, the watering insert 1 provides (a) an opening for water and air to enter the reservoir, (b) an upper surface 12 at the top end 4 of the watering insert 1 with a plurality of openings which allow airflow to the root system, (c) side walls 2 to separate the watering insert 1 from the growing medium, (d) a side opening, or interface structure 19 that seals to a wall of the plant growing container to allow side access to the reservoir directly through the containing vessel, and (e) a base 3 geometry that provides fins 17 with gaps or a plurality of openings so as to allow water to flow from the bottom end 5 of the watering insert 1 into the growing medium.

### BRIEF DESCRIPTION OF THE VIEWS OF DRAWINGS AS EXEMPLARY EMBODIMENTS OF THE INVENTIVE CONCEPT

FIG 1 depicts an isometric view of an embodiment of the watering insert 1 in which the overall contour is an inverted cuplike structure having a tapered sidewall 2.

FIG 2 illustrates a sectional side view of the watering insert 1 as seen from the perspective of section line 2-2 of FIG 1.

FIG 3 shows a view of the bottom end 5 of an embodiment of the watering insert 1 in which apertures and holes of the upper surface 12 of the top end 4, and the fins 17 of the base 3 are shown.

Table of Nomenclature & Part Numbers of Invention

```
  1. Watering insert
  2. Sidewall
  3. Base
  4. Top end
  5. Bottom end
  6. Ledge
  7. Left leg
  8. Right leg
  9. Collar
10. Lip
11. Mouth
12. Upper surface (solid or mesh)
13. Oblong hole
14. Circular aperture
15. Flange
16. Shelf
17. Fin
18. Tab
19. Interface structure
20. Pipe
```

### DETAILED DESCRIPTION OF THE INVENTION

The objects, features, and advantages of the inventive concept presented in this application are more readily understood when referring to the accompanying drawings. The drawings, totaling three figures, show the basic components and functions of embodiments and/or methods of use. In the several figures, like reference numbers are used in each figure to correspond to the same component as may be depicted in other figures.

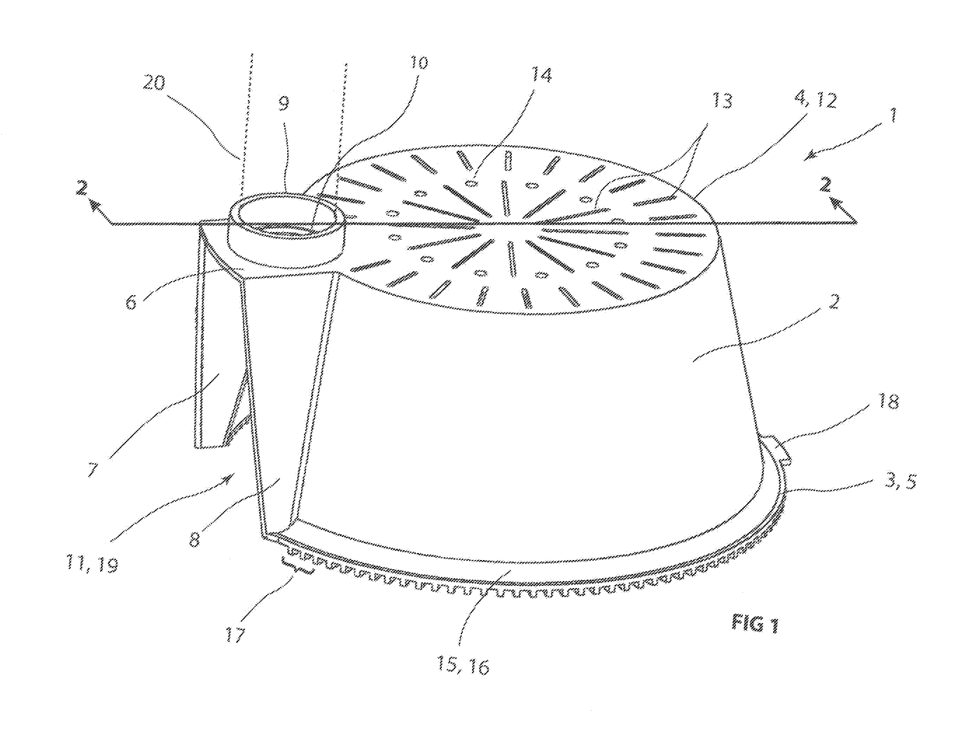

The discussion of the present inventive concept will be initiated with FIG 1, which illustrates an isometric view of one embodiment of the watering insert 1 in which the overall contour is an inverted cuplike structure having a tapered sidewall 2. It is to fee noted that other embodiments of the inventive concept comprise a variety of geometric contours, including box-shaped, oval-shaped, or other shapes which correspond directly with the interior of any specific plant growing container.

FIG 1 depicts that the tapered sidewall 2 of the watering insert 1 can create a space between the sidewall 2 of the invention and the plant growing container. This created space is where water is transferred from the watering insert 1 into the growing medium. Further, the taper on the sidewall 2 creates a geometry that allows multiple copies of the invention to stack and nest on each other. FIG. 1 shows, on the upper surface 12 of the top end 4, a multiplicity of oblong holes 13 and circular apertures 14 that permit air and water to transition from the watering insert 1 to the growing medium and plant root ball.

An interface structure 19, consisting of a left leg 7, a right leg 8, and a ledge 6, forms a mouth 11 opening. The edges of the legs and ledge 7, 8, 6 must be placed abuttingly to an interior wall of the plant growing container. In some embodiments, the mouth 11 the interface structure 19 may be sealed shut, to further greater retention time of the water supply. Noting the base 3 of the watering insert 1 there is seen a flange 15 forming a horizontal shelf 16, which shelf provides a retention location for growing medium that is inserted atop the watering insert 1. The shelf 16 accommodates the weight of growing medium placed atop it and provides additional stability to the watering insert 1.

Further, in FIG. 1, it is shown that the bottom surface of the flange 15 manifests a series of regularly-spaced fins 17 which provide gaps to allow water to flow from the bottommost section of the watering insert 1. A compatible hollow pipe 20 may be inserted into a collar 9 attached atop the ledge 6 of the watering insert 1 for the periodic supplying of water to the watering insert 1. An interior lip 10, is partially visible at the lower section of the collar 9, which lip serves to restrain the pipe 20 from extending into the water reservoir created within the watering insert 1. At least one tab 18 constructed integrally with the flange 15 extends from the base 3 so as to function as a spacer.

When the watering insert 1 is placed into a growing container, the interface structure 19, being diametrically opposite the tab 18, is thereby forced against the plant growing container, thus creating a tight seal between the growing container and the mouth of the interface structure 19. In different embodiments of the inventive concept, the mouth 11 may be sealed shut by the providing of additional material to seal the left and right legs 7, 8, and the ledge 6.

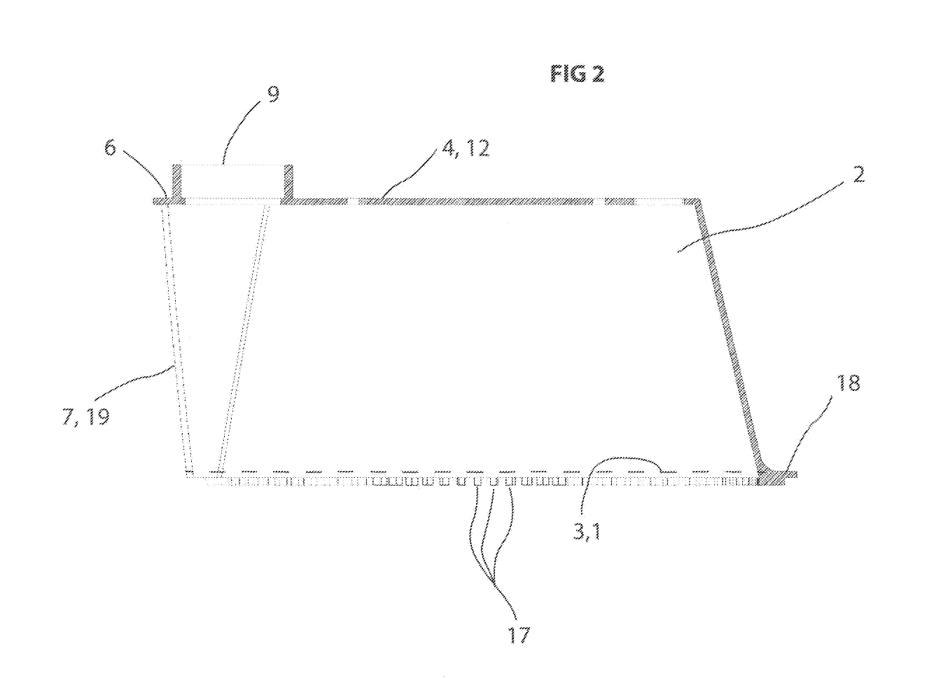

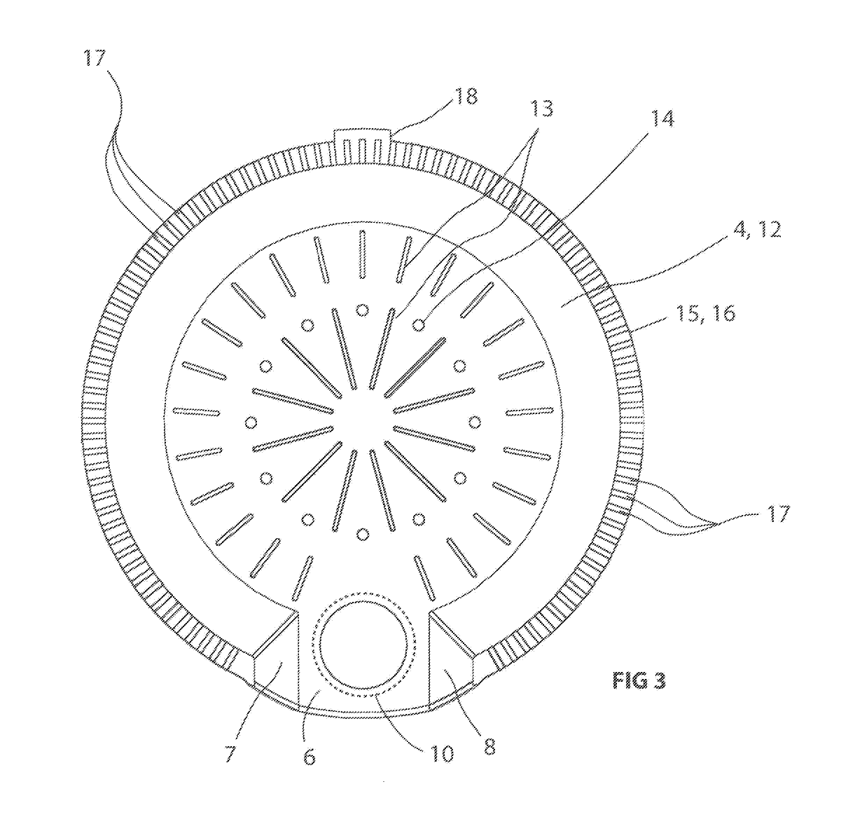

FIG 2 presents a cutaway sectional view of the watering insert 1 as seen from the perspective of section line 2-2 of FIG 1. FIG 3 is a bottom view of the watering insert 1 looking upwards. Predominantly visible in FIG 3 is the bottom of the upper surface 12, further showing the plurality of oblong holes 13 and circular apertures 14. The lower opening of the collar 9 is shown as it is located upon the ledge 6. The symmetrically-spaced fins 17 of the flange 15, are shown as they are constructed directly beneath the shelf 16.

While preferred embodiments of the present inventive method have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Accordingly, it is intended that this inventive concept be inclusive of such variations, changes, and substitutions, as described by the scope of the claims presented herein.

What is claimed is:

1. A mechanical device for insertion into the interior space of a plant growing container for the purpose of providing evenly-distributed, continuous watering to said plant and a corresponding growing medium of the plant, the device comprising:
a structure having sidewalls, a top end with an upper surface, an open bottom end, a circumferential flange about the bottom end, said flange forming an upper-oriented shelf having bottom-attached, spaced-apart fins, a tab extending horizontally outward from the flange, a vertically-oriented interface structure further comprising left and right legs forming an open mouth, a ledge, and a collar with a through-hole.

2. The watering insert as in claim 1, wherein a section of material is permanently attached to the edges of the ledge, the left leg, and right leg of the interface structure, thereby sealing the month.

3. The watering insert as in claim 1, further comprising (a) an internal circumferential lip structured onto the bottom segment of the collar and (b) a cylindrical pipe having an external diameter corresponding to the interior diameter of said collar.

4. The watering insert as in claim 1, wherein the general contour of the structure consists a rounded, cup-like form, wherein the sidewall tapers outward from the circumference-of the top-end toward a larger-circumferenced bottom end.

5. The watering insert as in claim 1, wherein said upper surface is constructed with symmetrically-spaced circular apertures and oblong holes.

6. The watering insert as in claim 1, wherein said upper surface comprises a mesh-like material.

7. The watering insert as in claim 1, wherein the outer diameter of the flange is approximately two (2.0) inches less than the interior diameter of a 5-gallon plastic bucket.

8. The watering insert as in claim 1, further comprising a dipstick wicking device for insertion into the collar for detecting the level of water internal to the watering insert.

9. The watering insert as in claim 1, wherein the general contour and dimensions of the structure consists of a shape selected from the group consisting of plant growing containers.

10. A method for providing evenly-distributed, continuous water supply to a plant and its growing medium, said plant and growing medium to be confined entirely within a plant growing container, the method comprising the steps of:
a) providing a device structured with sidewalls, a top end with an upper surface, an open bottom end, a circumferential flange about the bottom end, said flange forming an upper-oriented shelf having bottom-attached spaced-apart fins, a tab extending horizontally outward from the flange, a vertically-oriented interface structure further comprising left and right legs forming an open mouth, a ledge, and a collar having a through-hole,
b) placing the device, bottom end downward, into the plant growing container with the bottom end resting on the container and the interface structure abutting an interior wall of the plant growing container;
c) inserting a length of hollow pipe into the through-hole of the collar;
d) providing an initial quantity of growing medium atop and around the device;
e) inserting the plant, and any attached rootball, onto the upper surface of the device;
f) continuing to place additional growing medium within the plant growing container to a desired level; and
g) providing a quantity of water into the device by means of the hollow pipe.

11. The method as in claim 10, wherein a section of material is permanently attached to the edges of the ledge, the left leg, and right leg of the interface structure, thereby sealing the mouth.

12. The method as in claim 10, further comprising (a) an internal circumferential lip structured onto the bottom segment of the collar, said lip having an internal diameter corresponding to the internal diameter of said hollow pipe.

13. The method as in claim 10, wherein the general contour of the device consists a rounded, cup-like form, wherein the sidewall tapers outward from the circumference of the top end toward a larger-circumferenced bottom end.

14. The method as in claim 10, wherein said upper surface is constructed with symmetrically-spaced circular apertures and oblong holes.

15. The method as in claim 10, wherein said upper surface comprises a mesh-like material.

16. The method as in claim 10, wherein the outer diameter of the flange is approximately two (2.0) inches less than the interior diameter of a 5-gallon plastic bucket.

17. The method as in claim 10, further comprising a dipstick wicking device for detecting the level of water internal to the device.

18. The method insert as in claim 10, wherein the general contour and dimensions of the device consists of a shape selected from the group consisting of plant growing containers.
